(19) United States
(12) Patent Application Publication
(10) Pub. No.: US 2026/0262142 A1
(43) Pub. Date: Sep. 3, 2026

(54) POWER SUPPLY DEVICE AND SYSTEM HAVING AN INDUCTION COOKING APPLIANCE AND A POWER SUPPLY DEVICE

(71) Applicant: ELECTROLUX APPLIANCES AKTIEBOLAG, Stockholm (SE)

(72) Inventors: Alex VIROLI, Forli (IT); Massimo NOSTRO, Forli (IT); Filippo MARTINI, Forli (IT); Massimo ZANGOLI, Forli (IT); Michele FORTI, Forli (IT)

(21) Appl. No.: 19/163,439

(22) PCT Filed: Feb. 21, 2024
(86) PCT No.: PCT/EP2024/054462

§ 371 Date: Sep. 9, 2025

(30) Foreign Application Priority Data
Mar. 14, 2023 (EP) 23161934.7

(51) Int. Cl. H05B 6/12; H05B 1/02; H05B 6/04; H05B 6/06

(52) U.S. Cl. CPC H05B 6/1236; H05B 1/0266; H05B 6/04; H05B 6/065; H05B 2213/06

(57) ABSTRACT

A power supply device is provided for supplying power to an electrical device. The power supply device includes a receiving coil that is configured to interact with an electromagnetic field generated, in use, by at least one induction coil of an induction cooking appliance, and is configured to generate an electrical energy signal in function of the electromagnetic field. The power supply device further includes a conversion unit operatively connected to the receiving coil and configured to convert the electrical energy signal into an output signal; and an output interface operatively connected to the conversion unit and configured to be connected to the electrical device and to provide the output signal to the electrical device.

The present invention relates to a power supply device for powering electrical devices and configured to be coupled to an induction cooking appliance, preferentially an induction cooking hob.

Advantageously, the present invention also relates to a system having an induction cooking appliance, preferentially an induction cooking hob, for the thermal treatment of food products, and a power supply device coupleable and/or coupled to the induction cooking appliance.

It is known that the preparation of food products comes along with the use of cooking appliances, cooking vessels and electrical devices such as weight scales, temperature sensors, mixers and the like.

The electrical devices must be typically connected to the mains 230V alternating current supply for supplying the needed power. This, however, means that a free mains supply need to be available in the kitchen and/or the distance between e.g. the cooking vessel and the electrical device may not be convenient.

The present invention aims to increase the user experience by improving the handling of the electrical devices used during cooking operations.

According to the present invention, there is provided a power supply device and a system having an induction cooking appliance and a power supply device.

Preferred non-limiting embodiments are claimed in the claims directly or indirectly depending on the independent claims.

In addition, according to the present invention, there is provided a power supply device for supplying power to an electrical device and configured to be coupled to an induction cooking appliance.

The power supply device comprises:
a receiving coil configured to interact with an electromagnetic field generated, in use, by at least one induction coil of the induction cooking appliance and to generate an electrical energy signal in function of the electromagnetic field generated, in use, by the induction coil;
a conversion unit operatively connected to the receiving coil and configured to convert the electrical energy signal originating from the receiving coil into an output electrical energy signal; and
an output interface being operatively connected to the conversion unit and configured to be connected to the electrical device and to provide the output electrical energy signal to the electrical device.

By having the power supply device it is possible to power the electrical device without the need to connect the electrical device to a mains power supply. Moreover, this allows to avoid clutter in a kitchen environment.

According to some preferred non-limiting embodiments, the conversion unit may be configured to convert the electrical energy signal into a direct current output electrical energy signal.

Such a solution is advantageous as many electrical devices are already foreseen to be powered by a direct current energy signal.

Preferentially, the conversion unit may be configured to convert the electrical energy signal into a 5V direct current output electrical energy signal.

This is advantageous as many electrical devices are foreseen to be powered, e.g. being charged, by a 5V direct current energy signal.

According to some preferred non-limiting embodiments, the output interface comprises a socket configured to receive a plug connected to the electrical device. Such a solution allows to easily connect the electrical device to the power supply device.

Preferentially, the socket corresponds to the Universal Serial Bus standard. In this way one ensures that no additional equipment is needed, but the user relies already on equipment which is present in a typical household.

According to some preferred non-limiting embodiments, the power supply device may further comprise a housing having a bottom portion configured to be put into contact with a surface of the induction cooking appliance. The receiving coil is arranged within the bottom portion of the housing. In this way one ensures an efficient coupling of the electromagnetic field generated by the induction coil with the receiving coil.

Preferentially, the bottom portion may have a circular cross-section. In this way one adjusts the shape of the bottom portion to the shape of a typical induction coil.

In addition, according to the present invention, there is provided a system comprising an induction cooking appliance having at least one induction coil and the power supply device. Thereby, the power supply device is configured to be placed on and/or is placed on a support surface of the induction cooking appliance and such to be placed adjacent to the induction coil. The induction cooking appliance is controllable such that the induction coil generates an electromagnetic field interacting with the receiving coil for generating the electrical energy signal. In this way, one can easily transfer energy and such that the power supply device can power at least one electrical device.

It should be noted that the term “adjacent” indicates that the induction coil can interact with the receiving coil or in other words, in use, the electromagnetic field of the induction coil can interact with the receiving coil so as to transfer energy by means of induction from the induction coil to the receiving coil.

According to some preferred non-limiting embodiments, the induction cooking appliance may comprise at least one heating zone configured to support a cooking vessel. The heating zone may comprise the induction coil. In this way, one ensures that no extra induction coil is used for the interaction with the receiving coil, but with an induction coil which is anyways

Preferentially, the induction cooking appliance may comprise a plurality of heating zones, configured to support a cooking vessel and each having at least one induction coil.

In this way, it is possible to contemporaneously power an electronic device by the power supply device and to thermally treat a food product.

According to some possible non-limiting embodiments, each one of the induction coils may be configured to interact with the receiving coil. In this way, one is not limited in the possible choice of which induction coil to use for a thermal treatment process and for interacting with the power supply device.

According to some possible non-limiting embodiments, the induction cooking appliance may comprise a control unit configured to control, preferentially to selectively control, the induction coil into:
a cooking configuration in which the induction coil is configured to heat a cooking vessel; and
a power supply configuration in which the induction coil is configured to interact with the receiving coil for generating the electrical energy signal.

In this way, a user has the possibility of choosing which function a specific induction coil shall execute.

According to some preferred non-limiting embodiments, the induction cooking appliance may comprises a user interface configured to allow for a user to control the induction coil so as to interact with the receiving coil and/or to execute a cooking operation.

Preferentially, the user interface may be configured to allow to selectively control at least one induction coil between the respective cooking configuration and the respective power supply configuration.

According to some possible non-limiting embodiments, the system May further comprise the electrical device and a connecting cable connected to the electrical device and the output interface.

Preferentially, the electrical device may comprise an energy storage unit and the power supply device may configured to supply the power for charging the energy storage unit.

In this way, it is possible to charge the electrical device while being void of any further connecting cable.

Preferentially, the electrical device may be an electrical cooking device.

A non-limiting embodiment of the present invention will now be described, by way of example, with reference to the accompanying drawings, in which:

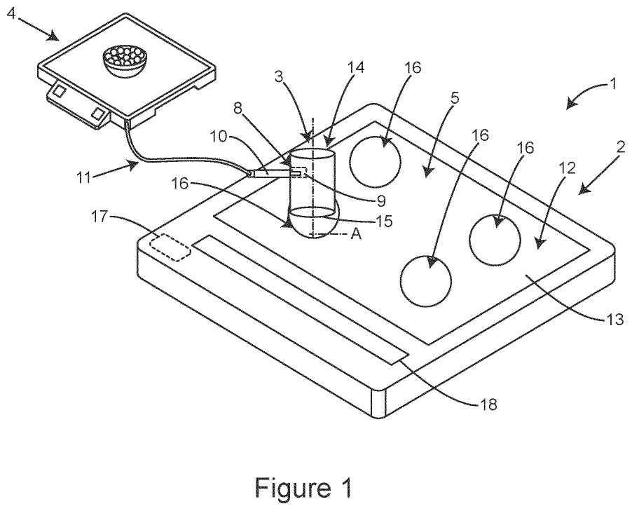

FIG. 1 is a schematic sketch of a system having an induction cooking appliance and a power supply device according to the present invention, with parts removed for clarity; and

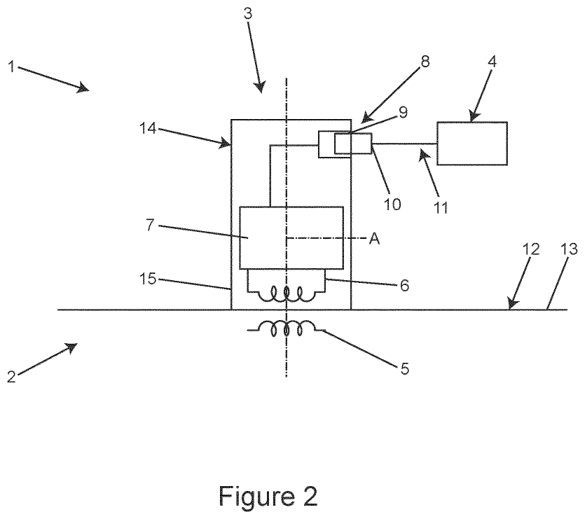

FIG. 2 is an enlarged view of a detail of FIG. 1, with parts removed for clarity.

With particular reference to FIG. 1, number 1 indicates as a whole a system 1 comprising an induction cooking appliance 2 for the thermal treatment, preferentially for the heating and/or cooking, of food products and a power supply device 3 placed on and/or configured to be placed on induction cooking appliance 2 and to interact with induction cooking appliance 2.

In the specific case shown, induction cooking appliance 2 may be an induction cooking hob. Induction cooking appliance 1 may comprise an induction cooking hob and an oven.

The food product to be thermally treated may be a single ingredient or a mixture of ingredients. It should also be noted that the food product to be treated may vary throughout the overall thermal treatment process; i.e. it may be possible to add or remove ingredients to the food product during the thermal treatment. In addition or alternatively, it may also possible that portions of the food product may disappear during the thermal treatment process (e.g. by means of evaporation or the like) and/or portions of the food product may be subjected to physical and/or chemical transformations.

System 1 may also comprise one or more electrical devices 4, preferentially electrical kitchen devices. Example electrical devices 4 may be chosen from the group of a weighing scale for weighing ingredients, a temperature sensor for measuring a temperature, mixers for mixing ingredients, blenders such as immersion blenders, and or the like.

Each electrical device 4 relies on the supply of electrical power during their operation. Therefore, electrical devices 4 may be provided with a powering unit. According to some embodiments, the powering unit may comprise an electrical storage, such as a battery.

As will be explained in more detail further below, power supply device 3 is configured to supply power to electrical device 4, preferentially for charging electrical device 4, more preferentially for charging the respective electrical storage.

Moreover, at least after charging of the respective electrical storage it is possible to operate electrical device 4.

Alternatively or in addition, power supply device 3 may be configured to supply power to electrical device 4 during operation of electrical device 4.

Induction cooking appliance 2 comprises at least one induction coil 5 configured to generate a respective electromagnetic field.

With particular reference to FIGS. 1 and 2, power supply device 3 comprises a receiving coil 6 configured to interact with an electromagnetic field generated, in use, by induction coil 5 and to generate an electrical energy signal in function of the electromagnetic field generated, in use, by the induction coil 5.

In particular, induction coil 5 and receiving coil 6 are configured such that energy transfer from induction coil 5 to receiving coil 6 occurs by means of induction energy transfer.

More specifically, the electromagnetic field generated by induction coil 5 is an alternating electromagnetic field and, additionally, also the resulting electrical energy signal is an alternating electrical energy signal.

In more detail, the alternating electromagnetic field generated, in use, by induction coil 5 generates by means of induction an alternating current within receiving coil 6.

Additionally, power supply device 3 comprises:
a conversion unit 7 operatively connected to receiving coil 6 and configured to convert the electrical energy signal originating from receiving coil 6 into an output electrical energy signal; and
an output interface 8 being operatively connected to conversion unit 7 and configured to be connected to at least one electrical device 4 and to provide (feed) the output electrical energy signal to electrical device 4.

In further detail, conversion unit 7 is configured to convert the alternate current signal electrical energy signal generated, in use, by receiving coil 6 into a direct current output electrical energy signal.

Preferentially conversion unit 7 may comprise an ac/dc converter configured to convert the alternate current signal electrical energy signal into the direct current output electrical energy signal.

Most preferentially, conversion unit 7, in particular the ac/dc converter, is configured to convert the electrical energy signal into a 5V direct current output electrical energy signal.

According to some preferred non-limiting embodiments, output interface 8 comprises a socket 9 configured to receive, preferentially to removably receive, a plug 10 connected to electrical device 4.

In particular, plug 10 may be an end portion of a connecting cable 11 connected to electrical device 4. Preferentially, connecting cable 11 may be removably connected not only to output interface 8, but also to electrical device 4.

According to some preferred non-limiting embodiments, system 1 may comprise plug 10 and/or connecting cable 11.

According to some preferred non-limiting embodiments, socket 9, and preferentially also plug 10, may correspond to the Universal Serial Bus standard.

With particular reference to FIG. 1, induction cooking appliance 2 may comprise a support surface 12 configured to carry one or more cooking vessels. In more detail, induction cooking appliance 2 may comprise a panel 13, preferentially of non-conducting material, even more particular of a glass-ceramic material, having support surface 12.

With particular reference to FIGS. 1 and 2, power supply device 3 is configured to be placed on support surface 12.

Preferentially, power supply device 3 may further comprise a housing 14 having a bottom portion 15 configured to be put into contact with support surface 12. In particular, bottom portion 15 may comprise an engagement surface configured to be put into contact with support surface 12.

More specifically, receiving coil 6 is arranged within bottom portion 15.

In further detail, housing 14 may extend along an axis A, preferentially axis A being perpendicular to support surface 12 with power supply device 3 being placed on support surface 12.

Preferentially, at least bottom portion 15 may have a circular cross-section, preferentially with respect to a cross-sectional plane being perpendicular to axis A.

For example, power supply device 3 may have a cylindrical shape.

According to some possible non-limiting embodiments, power supply device 3 may have more than one output interface 8 and being configured to contemporaneously supply electrical energy to more than one electrical device 4.

According to some possible non-limiting embodiments, power supply device 3 may comprise an energy storage, such as a battery, connected to conversion unit 7 and/or receiving coil 6 and being configured to be charged by conversion unit 7 and/or receiving coil 6. Moreover, the energy storage may be configured to supply power to an electrical device 4 connected to one output interface 8.

With particular reference to FIG. 1, induction cooking appliance 2 may further comprise:
one or more heating zones 16, each one configured to receive at least one cooking vessel containing the food product to be thermally treated and configured to heat the respective cooking vessel; and
a control unit 17 configured to control, preferentially to selectively control, operation of each heating zone 16.

The cooking vessel may be of any kind. The cooking vessel could be a pot, a kettle, a baking tray, a pan, a plate, a bowl, ovenware, aluminum foil or the like. The cooking vessel could or could not comprise a respective lid.

In the specific case shown, induction cooking appliance 2 comprises a plurality of heating zones 16. Induction cooking appliance 2 could, however, comprise only one heating zone 16, two, three, four or even more heating zones.

According to some possible embodiments, heating zones 16 may be static (i.e. their relative positions are fixed) or heating zones 16 may be dynamic (i.e. each heating zone 16 may be defined in dependence on the respective position on which the respective cooking vessel may be placed.

According to some preferred non-limiting embodiments, each heating zone 16 may comprise one or more respective induction coils 5 configured to generate a respective electromagnetic field for interacting with the respective cooking vessel.

According to the shown embodiment, each heating zone 16 may be configured to indirectly heat the respective food product by heating the respective cooking vessel.

In further detail, induction coils 5 may face panel 13 from a first face opposite to support surface 12. In other words, with the cooking vessel or power supply device 3 being placed on support surface 12 panel 13 is interposed between the respective induction coil 5 and the cooking vessel or power supply device 3.

According to some possible non-limiting embodiments, only one of the plurality of induction coils 5 may be configured to interact with receiving coil 6 with power supply device 3 being placed on support surface 12 and adjacent to the respective induction coil 5.

Alternatively, more than one or even all induction coils 5 may be configured to interact with receiving coil 6 with power supply device 3 being placed on support surface 12 and adjacent to the respective induction coil 5.

Thus, in use, a user places power supply device 3 on support surface 12 and adjacent to the respective induction coil 5 so as to allow for energy transfer from induction coil 5 to receiving coil 6.

It should be noted that the term adjacent indicates that the arrangement of power supply device 3 allows to transfer energy from the respective induction coil 5 to receiving coil 6. In other words, the respective induction coil 5 and receiving coil 6 can interact with one another.

According to some preferred non-limiting embodiments, control unit 17 may be configured to selectively control one or more induction coils 5 into:
a respective cooking configuration in which the respective induction coil 5 is configured to heat a cooking vessel; and
a respective power supply configuration in which the respective induction coil 5 is configured to interact with receiving coil 6 for generating the electrical energy signal.

Preferentially, induction cooking appliance 2 may also comprise a user interface 18 configured to allow a user to instruct and/or control and/or communicate with induction cooking appliance 2.

In particular, user interface 18 may be configured to allow for a user to control at least one induction coil 5 so as to interact with receiving coil 5 or to execute a cooking operation (i.e. to interact with a cooking vessel).

In other words, user interface 18 may be configured to selectively allow a user to control at least one induction coil 5 into the respective cooking configuration or the respective power supply configuration.

E.g. with a cooking vessel being placed at the respective heating zone 16, the respective induction coil 5 is set, in use, into the cooking configuration. If power supply device 3 is placed on the respective heating zone 16, the respective induction coil 5 is set, in use, in the respective power supply configuration.

According to some possible non-limiting embodiments, induction cooking appliance 2 may comprise a housing seat configured to house power supply device 3, in particular when power supply device 3 is not used for powering an electrical device 4.

In use, power supply device 3 can be used to supply power to at least one electrical device 4.

Power supply device 3 is placed on induction cooking appliance 2 adjacent to at least one induction coil 5 (being configured to transfer energy to receiving coil 6) and the at least one induction coil 5 generates the respective electromagnetic field such to interact with receiving coil 6 and such to generate the electrical energy signal.

Moreover, conversion unit 7 converts the electrical energy signal into the output signal, which is then transferred through output interface 8 to electrical device 4 so as to power electrical device 4.

More specifically, connection between power supply device 3 and electrical device 4 is established through connecting cable 11 connected to output interface 8 and electrical device 4.

It should be noted that induction cooking appliance 2 can also execute the thermal treatment of a food product present within a respective cooking vessel. Thereby, the cooking vessel is heated by action of a first induction coil 5 and receiving coil 6 interacts with the electromagnetic field of a second induction coil 5.

It should be noted that it may be possible to also execute a thermal processing by operating each induction coil 5 for heating a respective cooking vessel and to maintain power supply device 3 ready for further use.

Clearly, changes may be made to power supply device 3 and/or cooking appliance 2 and/or system 1 without, however, departing from the scope of the present invention.

### LIST OF REFERENCE SIGNS

1 System
2 Induction cooking appliance
3 Power supply device
4 Electrical device
5 Induction coil
6 Receiving coil
7 Conversion unit
8 Output interface
9 Socket
10 Plug
11 Connecting cable
12 Support surface
13 Panel
14 Housing
15 Bottom portion
16 Heating zones
17 Control unit
18 User interface
A Axis

1. A power supply device for supplying power to an electrical device and configured to be coupled to an induction cooking appliance, the power supply device comprising:
a receiving coil configured to interact with an electromagnetic field generated, in use, by at least one induction coil of the induction cooking appliance and to generate an electrical energy signal in function of the electromagnetic field;
a conversion unit operatively connected to the receiving coil and configured to convert the electrical energy signal generated by the receiving coil into an output signal; and
an output interface being operatively connected to the conversion unit and configured to be connected to the electrical device and to provide the output signal to the electrical device.

2. The power supply device according to claim 1, wherein the conversion unit is configured to convert the electrical energy signal into a direct current output signal.

3. The power supply device according to claim 2, wherein the conversion unit is configured to convert the electrical energy signal into a 5V direct current output signal.

4. The power supply device according to claim 1, wherein the output interface comprises a socket configured to receive a plug connected to the electrical device.

5. The power supply device according to claim 4, wherein the socket corresponds to the Universal Serial Bus standard.

6. The power supply device according to claim 1, further comprising a housing having a bottom portion configured to be put into contact with a support surface of the induction cooking appliance; wherein the receiving coil is arranged within the bottom portion of the housing.

7. The power supply device according to claim 6, wherein the bottom portion has a circular cross-section.

8. A system comprising:
the power supply device according to claim 1; and
the induction cooking appliance.
wherein the power supply device is configured to be placed on a support surface of the induction cooking appliance and adjacent to the induction coil; and
wherein the induction cooking appliance is controllable such that the induction coil generates the electromagnetic field interacting with the receiving coil for generating the electrical energy signal.

9. The system according to claim 8, wherein the induction cooking appliance comprises at least one heating zone configured to support a cooking vessel; wherein the heating zone comprises the induction coil.

10. The system according to claim 8, wherein the induction cooking appliance comprises a plurality of heating zones, each heating zone of the plurality of heating zones configured to support a cooking vessel and comprising at least one induction coil configured to interact with the receiving coil.

11. The system according to claim 8, wherein the induction cooking appliance comprises a control unit configured to control the induction coil according to:
a cooking configuration in which the induction coil is configured to heat a cooking vessel; and
a power supply configuration in which the induction coil is configured to interact with the receiving coil for generating the electrical energy signal.

12. The system according to claim 8, wherein the induction cooking appliance comprises a user interface configured to allow for a user to selectively control the induction coil so as to interact with the receiving coil or to execute a cooking operation.

13. The system according to claim 8, further comprising the electrical device and a connecting cable connected to the electrical device and the output interface.

14. The system according to claim 8, further comprising the electrical device, wherein the electrical device comprises an energy storage unit and the power supply device is configured to supply power for charging the energy storage unit.

15. The system according to claim 8, further comprising the electrical device, wherein the electrical device is an electrical cooking device.

16. The system according to claim 15, wherein the electrical cooking device comprises at least one device selected from a group of devices consisting of:
a weighing scale,
a temperature sensor,
a mixer, and
a blender.

17. A system comprising:
an induction cooking appliance comprising a support surface for supporting a cooking vessel thereon, and an induction coil that is operable to heat the cooking vessel when supported on the support surface; and
a power supply device for supplying power to an electrical device,
wherein the system is configurable to assume a power supply configuration in which the power supply device rests on the support surface adjacent to the induction coil, and the induction coil is operated to generate an electromagnetic field, and
wherein the power supply device comprises:
a receiving coil configured to interact with the electromagnetic field generated by the induction coil when the system is in the power supply configuration, wherein the receiving coil is configured to generate an electrical energy signal in function of the electromagnetic field,
a conversion unit operatively connected to the receiving coil and configured to convert the electrical energy signal into an output signal, and
an output interface operatively connected to the conversion unit and configured to be connected to the electrical device and to provide the output signal to the electrical device.

18. The system according to claim 17, wherein the conversion unit is configured to convert the electrical energy signal into a direct current output signal.

19. The system according to claim 18, further comprising the electrical device and a cable electrically connecting the electrical device with the output interface of the power supply device.

20. The system according to claim 19, wherein the electrical device comprises at least one device selected from a group of devices consisting of:
a weighing scale,
a temperature sensor,
a mixer, and
a blender.
